(19) United States
(12) Patent Application Publication
(10) Pub. No.: US 2020/0092389 A1
(43) Pub. Date: Mar. 19, 2020

(54) METHOD AND SYSTEM FOR OPTIMISING THE DELIVERY OF CONTENT TO MOBILE DEVICES USING MICROZONES AND MACROZONES

(71) Applicant: Nigel Conolly, Killara (AU)

(72) Inventor: Nigel Conolly, Killara (AU)

(21) Appl. No.: 16/554,991

(22) Filed: Aug. 29, 2019

(30) Foreign Application Priority Data
Aug. 30, 2018 (AU) 2018903194

(51) Int. Cl. H04L 29/08; H04W 4/029; H04W 4/021

(52) U.S. Cl. CPC H04L 67/28; H04L 67/02; H04W 4/029; H04L 67/04; H04L 29/08702; H04L 69/329; H04W 4/021

(57) ABSTRACT

Herein is described a method and system for optimising the delivery of content to mobile devices using microzones and macrozones and their associated methodologies. The macrozone method reduces the amount of content transferred to mobile devices. The macrozone method simplifies the determination of relevant microzones. The macrozone method also reduces the communication required between server and mobile device. The microzone method simplifies calculations for determining proximity to locations and narrows the focus for delivery of information based on proximity. The microzone method combined with the macrozone method reduces the total calculations and communications required within the total system. The system is further optimised by using microtimes and microcategories. The creation and management of content relating to microzones, microtimes and microcategories is managed through a campaign management system. Users of mobile devices receive content that is relevant geographically and contextually; with a reduced impact on the mobile device's resources.

### TECHNICAL FIELD

The field of the invention relates to the system and method for delivery of content to mobile devices based on the location of mobile devices; where mobile devices have or are connected to a global positioning system. The field includes the use of the microzone and macrozone methods; and the management of content that relates to microzones and macrozones.

### BACKGROUND

Users of mobile devices want to receive content that is relevant and of interest to them, especially if it means they do not need look for the content and that reduces the impact on the power consumption of their mobile devices. Users do not want to receive a large amount of content especially if it is not relevant or of interest. Users do not want to use many different applications in the hope of receiving something that might be of interest or relevant. Users do not want their mobile devices to be drained of power through the use of multiple applications and the use of applications that have complex and continuous calculations requiring additional power.

### SUMMARY OF INVENTION

### Technical Problem

Typical methods of delivering content to mobile devices include the delivery of sending advertisements to as many mobile devices as possible through as many notification systems as possible. The problem the users of the mobile devices face is being overwhelmed by content. This leads to consumers being frustrated with the content providers, typically advertisers. This frustration leads to disengagement. This is a lose-lose situation for consumers and content providers.

Newer methods have attempted to resolve these issues by delivering content based on location. However, these systems are either too complex and require a lot of continual calculation and drain on the mobile device resources or are not narrow enough in their focus to be able to provide content that is relevant both locationally and contextually.

Currently a typical consumer will have subscribed to multiple content provider news feeds and deal notification applications (DNAs), such as Groupon or Scoopon.

Problem 1: subscribing to multiple Retailers and DNAs means there are just too many emails and different applications to go through in order to find anything of interest.

Problem 2: the DNAs send a lot of notifications about deals. The DNAs include a lot of deals in their notifications. There are too many deals to look through in order to find something that might be of interest.

Problem 3: notifications are sent to all subscribers at all times of the day. This means consumers get notifications often and feel bombarded by too many irrelevant notifications.

The result is the consumer gets notification fatigue and ends up deleting all emails or notifications from the content providers and DNAs.

Some attempts have been made to minimise the content being sent to mobile devices. For instance, some DNAs have implemented systems that send notifications that are categorised as ‘nearby’. However, the problem with these systems is that the classification of ‘nearby’ tends to mean: we'll send information for your suburb first, and then your city. In a world where most suburbs typically have tens of advertisements, if not hundreds, the information can still be overwhelming.

The end result is that the three main problems identified above still occur.

A fourth problem exists with other notification systems that use geography as a signal to trigger the sending is they require a reasonable amount of processing power from the total system, including the mobile device and the central server. Some systems expect the mobile device to calculate virtual boundaries or geofences on the fly depending on various parameters. These parameters fluctuate from moment-to-moment depending on the where the mobile device is, what else is around it, and what direction the mobile device is going. There are many parameters that need to be assessed and be used to do calculations on the fly. The net result is a drain on the battery.

A fifth problem that exists is that most other systems require users of the mobile applications to do some work, such as search for content. Those systems are ‘reactive’. They sit there waiting for a user to input information and will then respond to that.

The patent written herein provides a solution to the problems identified.

### Solution

To solve the problems identified a system needs to send only the notifications that are highly relevant to the owner of the mobile device. Highly relevant notifications are:

Very close to the consumer (user of a mobile device); and

Within a specific category of interest that has been chosen by the consumer; and

Within very small timeframes.

Therefore, the method herein describes how a system may be optimised to significantly reduce:

The number of notifications being sent to a consumer;

The amount of on the fly processing required by the total system (mobile device and content server); and

The amount of battery power used by the mobile device.

As such this patent is defining how to build a system that can manage the requirements.

Firstly, an essential component of the method is that the system only sends notifications to mobile devices when they enter microzones. Microzones are virtual geographic areas defined by a circle with a radius of no more than a standard city block. The size of this area is an important element of the method. This size means that a user of a mobile device will receive the notification when they are within a short walk from the location that is at the centre of the microzone. Typically the centre of the microzone is the location of the said content creator's business premise.

The content creator may be a retailer or a service provider or a government department. In the case of a retailer the notification could say for example: ‘lunch special in the next hour’, or ‘20% off product <name>’. In the case of a government the notification could say, for example: ‘a nearby walk-in-clinic has availability’; or health warnings or emergency alerts such as ‘bushfires nearby’.

Secondly, another essential component of the system is the macrozone method. An essential component of the method is the way the macrozone is calculated and the role the macrozone plays within the system.

A macrozone is a virtual area around the mobile device that is significantly larger than a microzone. There are two types of macrozone: standard and routed. A standard macrozone is calculated by creating a square around the mobile device that is multiple times bigger than a microzone. A routed macrozone is calculated by creating a predefined sized buffer around a planned route. The specifics of the calculation methods for both standard and routed macrozones are described in the detailed description section.

The macrozone plays an important role within the system, whereby it filters and therefore reduces the amount of data that the mobile device needs to communicate and receive from the server. It also reduces the number of times the mobile device needs to communicate with the server. This reduces the power required to run the mobile device and associated applications.

This method simplifies the calculation of what is relevant to a mobile device within an immediate local area; and results in only a small number of microzones being sent to a mobile device. The system will search its macrozone and select the microzones within it; and send those microzones to the mobile device. The mobile device will use that packet of microzones on its local storage as its reference to the system, without the additional need of communicating back to the system, for the period of time that the mobile device remains within the macrozone.

The microzones remain dormant on the device until the mobile device enters into one of the microzones, and then a notification will be received by the mobile device.

This reduces the amount of data that needs to be transferred between mobile device and system server. This reduces the complexity of such a system and reduces the impact on the mobile device's battery; and reduces the potential number of notifications that an end user may receive, ensuring that they only receive notifications that are acutely relevant due to location; therefore minimizing the noise of not so relevant notifications.

Optional components of the system include a method whereby the system only sends notifications to the mobile devices that are tuned into microcategories that the notification belongs to. Microcategories are narrowly defined topics or product types or even particular brands. Users of mobile devices will use the system to tune into microcategories of interest. For instance, one may only tune in to a category, such as ‘Men's—Hiking Shoes’. Or the category may be a particular retailer, brand or service provider; for example, ‘Kathmandu’. Therefore, the owner of the mobile device will only receive notifications about those microcategories of interest, eg: ‘Men's—Hiking Shoes’ or ‘Kathmandu’.

Another optional component includes a method that only sends notifications during microtimes. Microtimes are time windows of less than an hour. For example, a hair salon that has just had a cancellation, may want to try to fill the gap. They could create a notification that promotes the time slot being available. The notification would only be sent to mobile devices that:

Enter the microzone around that hair salon during that specific microtime; and

Have tuned into the microcategory that the hair salon is associated with.

Another example could be a restaurant sending notifications about a lunch special during the lunch hour. The user of the mobile device may only receive that notification if they are within the relevant combination of macrozone; microzone; microcategory; and microtime.

The result is the users of mobile devices only receive content that is highly relevant to their interests (microcategories) and their immediate surroundings (microzones) at appropriate times (microtimes). The users are delighted to receive the content because it is so relevant to them. This means they engage readily and positively in the content. This means the content campaigns have a significantly higher click through rate than traditional methods. The success of the campaigns increases. The result is a win-win for user and content creator.

Another challenge for users of mobile devices is that they have lots of different mobile software applications. Many of the mobile software applications send notifications and it becomes overwhelming to deal with all of them. Hence, another optional method described herein uses a single mobile device software application to receive notifications from all content creators. This reduces the need of having multiple mobile software applications.

Other optional methods that further optimize the system and ensure the user of the mobile device is not overwhelmed include:

Ensuring that a mobile device will only ever receive one notification per microzone per campaign per day;

Allowing the user to engage with the application anonymously, without needing to input an email address.

The system described is a proactive system, whereby the consumer need not continually enter content to search for content of interest. Rather, the system will proactively send content to the user of the mobile device once they enter the right combination of macrozone and microzone.

### BRIEF DESCRIPTION OF THE DRAWINGS

The above introduction to the invention and present techniques will be better understood when the present application is read in view of the following figures. Note the figures are not necessarily to scale and are drawn to represent the concept.

FIG. 1 illustrates the method for calculating a standard macrozone.

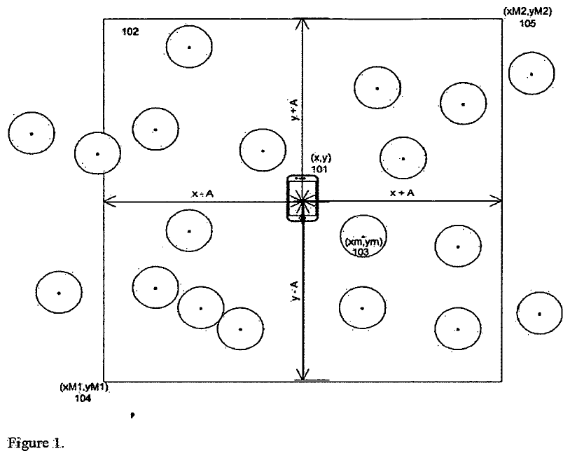

FIG. 2 illustrates the method for calculating a routed macrozone.

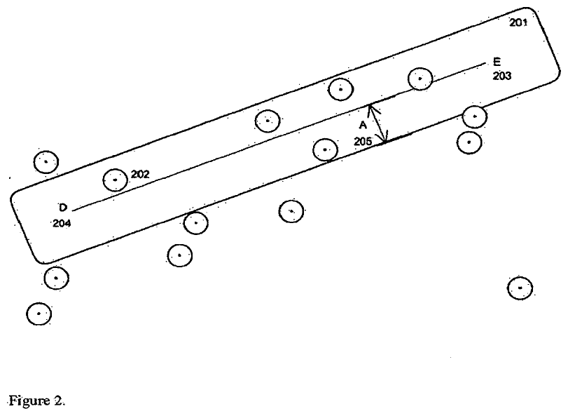

FIG. 3 illustrates the method for calculating if a mobile device enters a microzone within a standard macrozone.

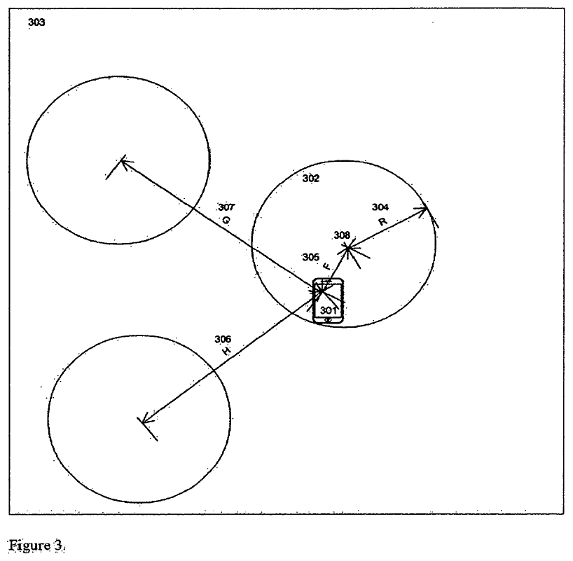

FIG. 4 illustrates the functional architecture of the campaign management system for optimizing the delivery of content to mobile devices using microzones, microtimes and microcategories.

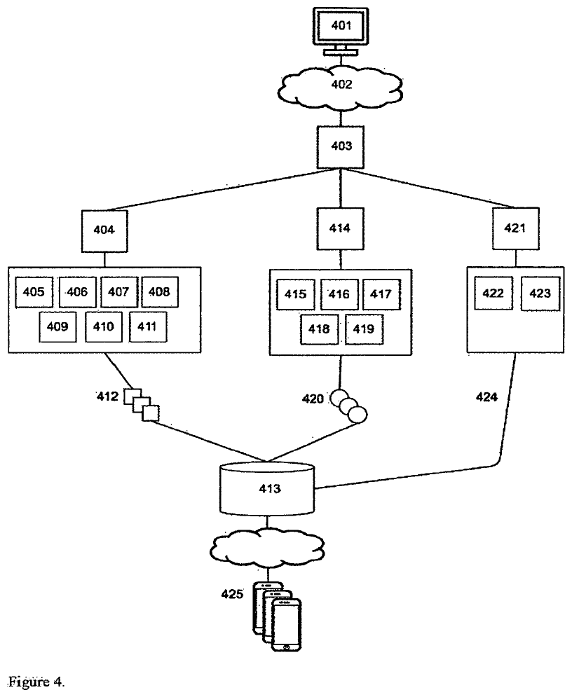

FIG. 5 illustrates the functional architecture of the mobile device application system for optimizing the receipt of content using microzones, microtimes and microcategories.

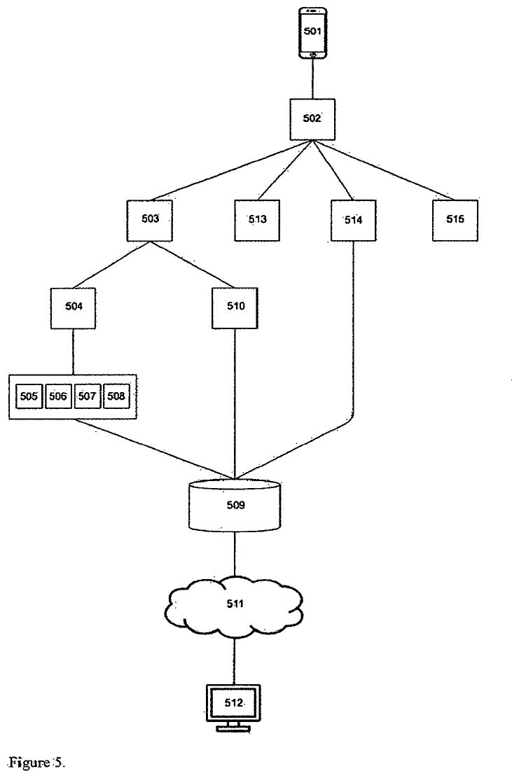

FIG. 6 illustrates an example logical workflow of the system, showing how content flows between a content creator and a consumer.

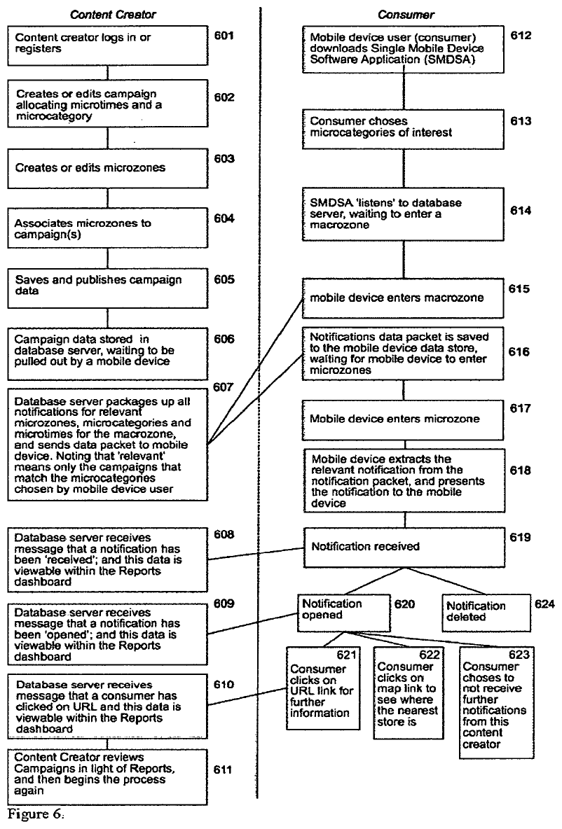

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DESCRIPTION OF EMBODIMENTS

Conceptual Model:

The uniqueness of this method is due to the combination of ensuring content is delivered to mobile devices through the use of the macrozone method and the microzone method.

Macrozone Method:

Unique approaches of this system include the macrozone method: the way in which the macrozone is calculated and used. Each mobile device has a series of macrozones that are unique to it. A macrozone is created when a mobile device first engages with the system. At that time, the system determines the latitude and longitude of the mobile device (101.) as x and y. It then calculates its first standard macrozone (102.) around that particular mobile device by calculating the minimum and maximum latitude (xM1 and xM2) and minimum and maximum longitude (yM1 and yM2). These are calculated by:

xM1=x−A; Equation 1

xM2=x+A; Equation 2

yM1=y−A; Equation 3

yM2=y+A; Equation 4

where A is a set distance, defined by 10 times the size of the radius of a microzone.

The result is a square defined by a minimum latitude and longitude: xM1, yM1 (104.); and a maximum latitude and longitude: xM2, yM2 (105.).

The macrozone is used to determine which microzones (103.) are within it. This is done by calculating whether the latitude and longitude of a microzone: xm, ym (103.), which describes the central point of a microzone, is between xM1, yM1 (104.) and xM2, yM2 (105.).

If the mobile device leaves its initial macrozone, then a new macrozone is created using the same method as the one described above. This reduces the need for continual sending and receiving of multiple data between the mobile device and server. In other words, the mobile device is optimizing its communication to the server, by only asking for information upon entering a new macrozone. This reduces the processing power needed by the mobile device, extending the battery time.

An alternative macrozone, known as the routed macrozone (202.), may be used. A routed macrozone is calculated by using the predefined distance of “A” as a buffer (205.) around a predefined route; where A is a set distance, defined by 10 times the size of the radius of a microzone. A route is defined as a path that a mobile device user wishes to take between two points, beginning at D (204.) and ending at E (203.).

The macrozone shown (201.) is a simplistic representation of a routed macrozone; in this case a straight-line route. A route may have turns and bends that follow roads or paths.

Microzone Method:

A microzone (302.) is static a virtual geographic area with a radius that is the length of a standard city block, which is between 80 metres and 274 metres (304). The centre point of the microzone is defined by a latitude and longitude (103. and 308.). The radius of the microzone is defined by a content creator and stored in the database.

Notifications are only ever sent to a mobile device when they enter a microzone that is part of the macrozone for that mobile device.

The method for determining whether a mobile device has entered a microzone is an essential component of the patent. This method reduces the complexity typically involved in this calculation. This calculation is typically determined by using the circle boundary as the feature against which to measure the point of the mobile device; however, representing a circle is a complex series of calculations and representations of latitudes and longitudes.

Instead, the method of the system proposed is a simpler method and is based on distance comparisons, such that if the distance between the mobile device and the centre point of the microzone (F, 305.) is less than the radius (R, 304.) of the microzone (302.), then the mobile device is within the microzone.

Hence, if F (305.)<R (304.), then the mobile device (301.) is within the microzone (302.).

Conversely, if the distance between the mobile device and other microzones is greater than the radius of the microzone (R) then they are not within the microzone.

For example, G (307.)>R (304.).

When the location of the mobile device changes, the new location of the mobile device is tested against the other microzones within the macrozone by using the same distance comparison technique. The system only needs to perform this calculation on the microzones within the macrozone for that particular mobile device; further reducing the drain on resources from the total system. This calculation is performed by the system on the mobile device, reducing the need to perform communication and calculation back and forth between mobile device and server.

Microcategories:

Optionally, the system will be made more efficient by reducing the number of microzones selected within a macrozone by filtering the microzones out that do not belong to the microcategories previously selected by the user of the mobile device. Microcategories are narrowly defined topics, product types, particular brands or specific service providers. These may include, for example: women's formal shoes, women's active wear, men's hair products, men's jeans, men's black work shoes, massage therapy, Chinese take away cuisine, or government health services.

Microtimes:

Optionally, the system will be made more efficient by reducing the number of microzones selected within a macrozone by filtering the microzones out that do not belong to the microtimes relevant to the time of day. Where a microtime relates to a time period of no more than one hour.

Using the total combination of microcategories, microtimes, macrozones and microzones ensures that a user of a mobile device only receives content that is relevant to them. By filtering the amount of information that an end user receives, reduces the amount of data transferred between server and mobile device, reducing the load on the total system.

Notifications:

Once a macrozone is defined for a mobile device, the single mobile device software application (SMDSA) sends that to the server. Once the system determines which microzones (103. or 202.) are within that macrozone it will send the mobile device a package of data that includes the microzones and the notifications associated with each microzone.

The notifications stored on the mobile device remain dormant until the mobile device enters a microzone. Once the mobile device enters a microzone then the single mobile device software application (SMDSA) produces a notification for that microzone.

Mobile Device:

A mobile device (301.) is a computing device comprising: a memory; a communication interface; and a processor enabled to determine geographic boundaries comprising a polygon, that is connected to a Global Positioning System (GPS) either wirelessly or directly with wires externally or internally. A mobile computing device could include a mobile phone, a tablet, a computer within a vehicle, a wearable device, or any computing device that is mobile or movable.

The Campaign Management System:

The content to be delivered to mobile devices is created within a campaign management system. A content creator has a computing device (401.) that is able to connect to the Internet. The computing device could be a desktop computer, a tablet, a mobile phone, or any other computing device capable of connecting to the Internet. A content creator is any person that aims to notify people about topics that may be relevant to at least one microzone.

The content creator connects to the campaign management system, which is a web-based application (402.), via a web address or URL.

The content creator logs in to the web based application via a login (403.).

They then enter the campaign management system home page. The content creator navigates to the campaign management system campaign page (404.). This is the entry point to managing campaigns, including editing and creating campaigns. At this point the content creator chooses to either edit or create a new campaign.

The content creator can create or edit the name of the campaign (405.). The name is a way of identifying the campaign.

The content creator can create or edit the company name (406.). This is the name of the organisation that is running the campaign.

The content creator can create or edit the notification (407.). The notification is the message and content intended to be delivered to the users of the SMDSA. Content may include information of any kind including, but not limited to: advertising material, news, alerts, including emergency notifications from government services or even private business services, reminders of a personal, business or government nature, computer code for running other computer related functions, for example an application programming interface; a link or connection to a digital payment system; a link to any other external URL; a link to any other external application, either directly through an application programming interface, or through a button that the Consumer needs to press to confirm the connection can be made.

Content is delivered in any kind of format, including but not limited to: text, sound, imagery (animated and static), audiovisual, and vibrations; computer programming code.

The content creator can create or edit a web address (408.). The web address is the URL that the content creator wants the consumer to navigate to in order to discover further details about the notification. This may include a link to an e-commerce site where the user is able to purchase a product, or just a link to the content creator's website that explains more about the notification. For instance, a content creator may be a Medical General Practice who may be advertising information about the new flu vaccine. The link may be to an information website about the flu vaccine and why it is beneficial to receive one. Or a content creator may be a hair salon that has just had a cancellation, and they are advertising an available slot in the next hour. In this case the link to the URL would likely be to a booking page or to their contacts page so people could ring to book in.

The content creator can create or edit the start date and end date of the campaign (409.).

The content creator can create or edit a time of day that the notification will begin sending and a time that the notification will stop sending (410.). The time period may be limited by one hour, a microtime.

The content creator can associate their campaign with a microcategory (411.). Microcategories are narrowly defined topics, product types, particular brands or specific service providers. These may include, but is not limited to: women's formal shoes, women's active wear, men's hair products, men's jeans, men's black work shoes, massage therapy, Chinese take away cuisine, or government health services.

Once the content creator has created the aforementioned details (campaign details), and then these are stored within a campaign database (413). The summary of these campaigns can be viewed within a summary page (412.).

The content creator needs to associate microzones to a specific campaign. The content creator enters the microzone management console (414.). This is the entry point to the area where content creators can create and edit microzones. This section is a digital mapping interface.

A single microzone may be created through an interface (415.) that allows:

Clicking or tapping on the digital map interface at the location of the centre point for the microzone; or

Using a single address geocoding tool. This tool allows a content creator to type an address into a field, press enter, and the digital mapping interface navigates to the actual location of the address. At this point the content creator may choose to add this location as the centre point of a new microzone.

Alternatively, a content creator may wish to create many microzones in one automated way. In this case, a bulk geocoding tool is used (416.). A content creator is able to add a list of addresses to the application and the system will geocode all the addresses automatically.

The microzones are created with a predefined radius (417.). A content creator may wish to change the position of the centre point of the microzone. This is done by clicking in the microzone and picking it up and dragging it to another position (418.).

A content creator may associate one or many microzones with one or many campaigns (419.).

The collection of microzones may be presented as a list or on the map as a set of polygons located at their defined positions (420.).

The campaign management console provides a reporting interface (421.). The reporting interface is where a set of analyses can be run and viewed by the content creator. Analyses may include a report for the number of times a notification for a particular campaign has been sent to mobile devices (422.). The report may be a set of numbers against each campaign or a graph representing the same. Analyses may also include a report for the number of notifications that have been clicked on by the users of the mobile devices (423.). This data may be presented in a table of numbers or in a graph.

All data for the campaign management system is stored in the database server (413.). All data includes but is not limited to the data related to the campaigns, microzones and reports. Data may flow between database server and reporting interface, as required (424.).

Functional Architecture of the SMDSA:

A Single Mobile Device Software Application (SMDSA) is a single mobile application designed for use by multiple content creators (502.). This is not an application that content creators customise for their own mobile applications. Instead, the intention is to ensure that the user of the SMDSA has access to campaigns from multiple content creators from the one mobile application. This minimizes the need for the user to have multiple applications on their mobile device for multiple content creators.

The SMDSA has an inbox page (503.). This page lists all notifications that have been received. In this page, a consumer may be able to: Open a notification (504.) or remove a notification (510.).

When a user opens a notification, they are taken to a new window (504.); upon which the consumer can choose to:

Open a link from within the notification for further information (505.);

Press a map link that opens a separate mapping application (506.) and may show directions from the mobile device's current location to the location to the nearest content creator's location of service provision (eg: a retailer's shop);

Choose to no longer receive notifications from that specific content creator (507.);

Choose to no longer receive notifications about that specific campaign (508.);

Report a notification for inappropriate content

The user of the SMDSA is able to choose the microcategories for which they wish to receive notifications (513.). This enables them to limit the notifications received to only be from these microcategories.

A user is able to define the route that they intend on taking (514.). They define their start point and end point within a mapping interface or a textual field for each address. Using existing route definition technologies, a route is determined; and sent as a data set to the database and application server (509.). The application server calculates a routed macrozone around the route; and then determines which microzones are within it. The resultant set of microzones is sent back to the mobile device as a data packet.

The consumer is able to view and edit a few parameters that have been saved against their use of the application (515.). For instance, a consumer may have chosen to ‘not receive any more messages from a particular sender’ from the time they received a message from that sender.

The data about mobile consumer actions within the mobile application is sent to the database server (509.). This information is sent when the actions occur. The data is not containing any information about the person, because there is no email address associated with the data.

A web based campaign management system (511.). The content creator navigates to the campaign management system in order to review the reports of their campaigns (511.). The content creator does this by using a computing device that is able to connect to the Internet (512.).

Logical Workflow of System:

Content creator logs in or registers to use the Campaign Management application, which is a web based application (601.).

Content creator creates or edits a campaign (602.). In the process the content creator allocates microtimes to the campaign and a microcategory to the campaign.

Content creator creates or edits one or many microzones for the campaign (603.). To create a microzone the content creator clicks on the map or geocodes a list of addresses.

Content creator then associates each microzone to a campaign or multiple campaigns (604.).

Content creator then saves and publishes the campaign data (605.).

The campaign data is stored within the database server (606.). The data will remain in the database server until a mobile device enters a macrozone that relates to the campaign data.

In the meantime, a mobile device user (consumer) downloads the Single Mobile Device Software Application (SMDSA) (612.).

The Consumer choses microcategories of interest (613.).

The SMDSA ‘listens’ to database server, waiting to enter a macrozone (614.). Alternatively, at this point if a consumer has defined a route they intend to take, the SMDSA sends the route to the database and application server. The application server calculates the routed macrozone around it.

Once the mobile device enters the macrozone, it then sends a message to the database server (615.). The database server then packages up all notifications (607.) for relevant microzones, microcategories and microtimes for the macrozone, and sends a data packet to mobile device. Noting that ‘relevant’ means only the campaigns that match the microcategories chosen by mobile device user.

The Notification Packet is saved to the mobile device data store, waiting for the mobile device to enter a microzone (616.).

The mobile device enters a microzone (617.).

The mobile device extracts the relevant notification from the Notification Packet, and presents the notification to the mobile device (618.).

The notification is presented by the SMDSA to the mobile device, as a received notification (619.).

Once a notification is received, the mobile device sends a message to the database server saying it was ‘received’ (608.). This information is then viewable within the Reports dashboard within the Campaign Management console for the content creator to review.

A consumer will either open or delete a notification. If the notification is deleted (624.) then that is the end of the communication for that particular campaign and consumer. If the notification is opened (620.) then the consumer will perform one of the following:

Click on the URL link in the notification for further information (621.);

Clicks on the map button to see where the nearest location for that content creator is (622.); or

Chooses not to receive further notifications from this content creator (623.).

Database server receives messages for when the consumer has clicked on the URL (610.). This data is then viewable within the reports page of the campaign management system.

Content creator can review campaign(s) in light of the reports delivered through the campaign management system; and then begins the process again (611.).

### CITATION LIST

### Australian Patents

2017228603—Bluedot—Reactive Hybrid Location Determination method and apparatus
Ser. No. 14/146,563; March 2017; Zinin; Cinarra Systems Pte Ltd.; Location and time-aware systems and methods for mobile user context detection
2013327433; (Ser. No. 13/674,003), September 2016, Angell et al., PayPal, Inc. (e-bay), Systems and methods for analyzing and reporting geofence performance metrics
2016202371, April 2016, Nallu et al., e-Bay, Systems and methods for in-vehicle navigated shopping
PCT/US2015/021244, App #2015236575, October 2015, Chenge et al., Retailmenot—Caching Geolocated Offers
WO/2015/148214, App #2015236576, October 2015, Randle, s., Retailmenot—Multi-stage geolocated offers
PCT/US2015/026179, WO 2015/161080, October 2015, REgo et al., Retailmenot—time Period Distribution of Offer Codes
WO/2015/123284, App #2015217230, August 2015, Bell et al., Retailmenot—event-based offers for a geofenced geographic area
PCT/US2014/061152, App #2014340441, April 2015, Geogoff et al., Retailmenot—providing offers and associated location information
Wo2015/123363—2015217150, August 2015, Scellato et al., Google Inc., Energy Efficient Location Determination
20130184009, September 2015, Attar et al., Google Inc., Providing hotspots to user devices within server-controlled zones
2009217429, King, G., Retailmenot, Method and System for Facilitating Access to a Promotional Offer

### American Patents

20160150372, May 2018, Harkey et al., Bank of America, Geolocation check-in system
Ser. No. 13/111,920, Doane et al., May 2018, Amazon Technologies Inc., Location-based mobile advertising
US 20150148061 A1, April 2018, Koukoumidis et al., Microsoft Technology Licensing LLC, Geofences from context and crowd-sourcing
20180091940, March 2018, Microsoft Technology Licensing, LLC, Defining a Contextual Geofence
20170034289, March 2018; Theobold, et al.; Kiltr Ltd; Network system and method for providing location targeted content to a mobile computing device
US 20170078842 A1, March 2018, Skyhook, Active geo-fence management
US 2017-0099381 A1, February 2018, Marti et al., Apple Inc. Category-based fence
WO2016/095120, February 2018, Lu et al., Huawei Technologies Ltd., Method for implementing geo-fencing and mobile device
20170230792, January 2018, Shaik; Google Inc.; Method and apparatus for providing target location reminders for a mobile device
20150163630 (Ser. No. 14/099,101), Hughes Jr., January 2018, Systems and methods for geo-location based message streams
61/925,437, Ser. No. 14/593,403, January 2018, Skyhook Wireless Inc., Active geo-fence management
20150100271, January 2018, Wang et. al., Google Inc., Providing points of interest to user devices in variable zones
20160037299, November 2017, Inc., Fisher et al. (U.S. Pat. No. 9,813,861), Media device that uses geolocated hotspots to deliver content data on a hyper-local basis; application Ser. No. 14/812,678
2017/0150319, May 2017, Bolton et. al., CollegeNET, Inc.—Adaptive location branding
20160353237, Shepherd et al., March 2017, Apple Inc., Location service management
Ser. No. 14/804,334, February 2017, Barron, et al., International Business Machines Corporation (IBM), Geo-fence management using a cluster analysis technique
61/925,437, Ser. No. 14/593,619, August 2016, Steger et al., Skyhook Wireless Inc. Geo-fence splitting
20160360338, August 2016, eBay Inc., Systems and method for configuring mobile device applications based on location
20130324160, December 2016, Sabatelli, et al., Apple Inc., Managing Alerts based on Context
20140162692 (application Ser. No. 13/710,838), March 2015, Li et al., Research in Motion Inc. (BlackBerry LTD), Geofencing System and Method
WO/2014/124395, PCT/US2014/015630, August 2014, Zaytzsev et al., Groupon, Consumer Device Payment Token Management
U.S. Pat. No. 9,341,487B2, July 2014, Bonhomme, J., Lytx Inc., Automatic Geofence Determination
20140135039, May 2014, Sartipi; Siamak; et al., Blackberry, Method, System and Apparatus for Determining Geofence Data based on Estimated time of Arrival
20140065965, March 2014, Prasad, Ford Global Technologies LLC.—Context Adaptive Content Interaction Platform for Use with a Nomadic Device
20110313840, February 2014, Mason et al., Groupon; System and methods for providing location based discount retailing
20140195110, January 2014, Kim et. al., LG Electronics Inc., Vehicle terminal and location-based content sharing system having the same
Ser. No. 13/646,577; January 2014, Wright, et al.; Aegis Mobility Inc.; Disseminating targeted location-based content to mobile device users
U.S. Pat. No. 8,755,824B1, June 2013, Wang et al., Google, Clustering geofence-based alerts for mobile devices
2013/0072226, March 2013, Thramann—Systems and Methods for Tracking Mobile Devices
2013/0035116, February 2013, Hymel et al., Research in Motion Inc. (AKA BlackBerry)—System and method for determining action spot locations relative to the location of a mobile device
2012/0295645, November 2012, Yariv et. al.; Microsoft Corporation, Delayed and Space-time bound notifications
2012/0265841, October 2012, Ross et al., Systems and Methods for transmitting information, alerts, and/or comments to participants based on location information
2012/0220314, August 2012, Altman, Loopt Inc.—Location Based Advertising Message Serving For mobile Communication Devices
US 20130326137 A1, May 2012, Qualcomm Inc., Methods and systems for retrieving and caching geofence data
20110148634, June 2011, Putz; Jason T.—Lockheed Martin—Predictive Geofence Crossing

1. A system and method for optimizing the delivery of content to mobile devices using the standard macrozone and microzone method; where a standard macrozone is a square boundary around a mobile device that is calculated by determining a minimum and maximum latitude and a minimum and maximum longitude; where the distance from the mobile device to each of the minimum and maximum latitude and longitudes is defined by 10 times the size of the radius of a microzone; where a microzone is a static virtual geographic area with a radius that is the length of a standard city block, which is between 80 metres and 274 metres; that has its centre point defined by a latitude and longitude, which is determined by using the coordinates provided by a Global Positioning System that is connected to the mobile device; and where a mobile device will only ever receive content if it enters a microzone that is within a standard macrozone; and where the system determines that a mobile device enters a microzone when the distance from the mobile device to the centrepoint of the microzone is less than the distance of the radius of the microzone; and where this later calculation occurs on the mobile device.

2. A system and method for optimizing the delivery of content to mobile devices using the routed macrozone and microzone method; where a routed macrozone is calculated by using the predefined distance as a buffer around a predefined route; where the buffer distance, is defined by 10 times the size of the radius of a microzone; and where a route is defined as a path that a mobile device user wishes to take between two points; where a microzone is a static virtual geographic area with a radius that is the length of a standard city block, which is between 80 metres and 274 metres; that has its centre point defined by a latitude and longitude, which is determined by using the coordinates provided by a Global Positioning System that is connected to the mobile device; and where a mobile device will only ever receive content if it enters a microzone that is within a routed macrozone; and where the system determines that a mobile device enters a microzone when the distance from the mobile device to the centrepoint of the microzone is less than the distance of the radius of the microzone; and where this later calculation occurs on the mobile device.

3. A microzone is entered into the system by a content creator using a campaign management system that automatically creates the microzone based on the input of an address by the content creator; and where the radius of the microzone is a predefined distance, no larger than a standard city block.

4. A macrozone is created on the mobile device and is sent to the campaign management system; where the system then selects the microzones that are within the macrozone and sends the selected microzones as a data packet to the mobile device, for storage in the mobile device's local memory whilst the mobile device remains within the macrozone.

5. A microzone may include a location that may be of interest to a user of the mobile device, where this could be any of the following: a retailer location, or the location of a government department, or a public space of interest that the government may wish to encourage people to engage with, or any other location defined by a content creator that may be of interest to a user of the mobile device.

6. The method of claims 1 and 2, wherein a notification is any information that the content creator wishes to provide to the users of a mobile device; and where this information is associated with one or many microzones; and may include, but is not limited to: advertising material, news, alerts from both government services and private business services, reminders of a personal or business nature, computer code for running other computer related functions, for example an application programming interface, a link or connection to a digital payment system, a link to any other external application, either directly through an application programming interface, or through a digital button that the consumer needs to press to confirm the connection can be made, a link to any other external Uniform Resource Locator (URL), or any information that may be of use to the user of a mobile device.

7. The method of claim 6, wherein the notification may be delivered in any kind of format, including but not limited to: text, sound, imagery (animated and static), audiovisual, and vibrations; wherein sound and audiovisual information can interface with 3D localised audio processing systems to provide acoustics binaurally.

8. The method of claim 1, where the user of the mobile device only receives one notification per day per campaign per microzone; where said delivered notification is recorded in the system, noting the time the notification is received, and from which campaign, and in which microzone.

9. The mobile device communicates with the campaign management system via a cellular or wireless network.

10. A microzone may be associated with a microcategory, and a user of a mobile device may elect to receive content for a microcategory or multiple microcategories; and the system may filter the microzones sent to a mobile device based on the microcategories selected by the user of the mobile device.

11. The method of claim 10; where microcategories are narrowly defined topics, product types, particular brands or specific service providers, including, for example, but not limited to: women's formal shoes, women's active wear, men's hair products, men's jeans, men's black work shoes, massage therapy, Chinese take away cuisine, or government health services; and where the microcategory is created by the content creator within the campaign management system; and the microcategory is associated with a microzone and a notification and a campaign; and ensures that the notification may only be sent to users of a mobile device that have chosen to receive content for that specific microcategory.

12. A microzone may be associated with microtimes; where a microtime is no more than one hour; and where the microtime is created by the content creator within the campaign management system; and ensures that the notification may only be sent to users of a mobile device during that microtime.

13. The system may use microtimes and microcategories for any particular microzone and campaign.

14. The method of claim 1, where a campaign management system is a software application and a database server and an application server that are accessible through a graphical user interface through a Uniform Resource Locator (URL); through which a content creator can create and manage campaigns, microzones, microtimes and notifications.

15. The method of claim 14, wherein a microzone is created in the campaign management system by the content creator nominating a central point; which is done by either clicking or touching a location on a digital mapping interface for the location of the central point, or by typing an address for the location of the central point and geocoding it using 3^{rd} party geocoding address tools, or by entering an address into the system via a separate digital text file which is then geocoded by a 3^{rd} party geocoding address tool; and upon a central point being defined the system automatically creates a predefined distance buffer around it; and saves that microzone in the database.

16. The method of claim 14, wherein a campaign is created by a content creator through the campaign management system, and a campaign is a combination of a microzone and a notification, and may include a microcategory and a microtime; and where one notification may be associated with either one or many microzones.

17. The campaign management system receives a data record when a mobile device performs a certain action, where an action may include a notification was received by a mobile device, or a notification was opened by a mobile device; and a content creator is able to review data records of actions that relate to their campaigns.

18. A system and method that includes a single mobile device software application, that means all notifications are delivered through the single mobile device software application; and allows multiple content creators to deliver content through the single mobile device software application; and allows the user of the single mobile device software application to receive content from multiple content creators through the single mobile device software application.

19. Where a mobile device is a computing device comprising: a memory; a communication interface; and a processor enabled to determine geographic boundaries comprising a polygon; that is connected to a Global Positioning System (GPS) either wirelessly or directly with wires externally or internally; where the computing device could include a mobile phone, a tablet, a computer within a vehicle, a wearable device, or any computing device that is movable.

20. The method of claim 18, where the user of the single mobile device software application is able to select specific microcategories that are of interest and for which they wish to receive notifications.
